(19) United States
(12) Patent Application Publication
(10) Pub. No.: US 2015/0090738 A1
(43) Pub. Date: Apr. 2, 2015

(54) ACTUATING DEVICE FOR A DISPENSING PUMP OF A DISPENSER

(71) Applicant: EMSAR S.p.A, San Giovanni Teatino (CH) (IT)

(72) Inventor: Matteo CAPORALE, PESCARA (IT)

(73) Assignee: EMSAR S.p.A, San Giovanni Teatino (CH) (IT)

(21) Appl. No.: 14/039,745

(22) Filed: Sep. 27, 2013

(51) Int. Cl. B67D 7/60; B67D 7/02

(52) U.S. Cl. CPC B67D 7/60; B67D 7/0288
USPC 222/205

(57) ABSTRACT

An actuating device for a dispensing pump of a dispenser is configured to be used on a container, in an upward position of the container. The actuating device includes a pouring cup and a connecting device. The pouring cup defines an inner chamber for receiving a metered amount of a product. The connecting device includes a hollow structure extending along a longitudinal axis between at least a first end and an opposite second end. The structure is connected and supports the pouring cup. The structure defines a channel extending along the axis between an input opening and an output opening. The output opening emerges into the inner chamber whereby the channel communicates with the inner chamber. The second end includes a connecting portion configured to be connected to a hollow stem of the dispensing pump whereby the channel communicates with a dispensing cavity defined by the stem.

### TECHNICAL FIELD

The present invention relates to an actuating device for a dispensing pump of a dispenser, i.e. a dosing device able to be applied to an opening of a container, for example a neck of a bottle, to dispense the product (liquid) contained therein.

### BACKGROUND ART

In particular, the present invention relates to an actuating device for a dispensing pump of the type comprising a containment body with substantially axial-symmetric geometry, internally hollow and able to be inserted in an opening of a container.

WO2011/074024 discloses an example of this type of dispensing pump. The containment body of the dispensing pump has a bottom portion provided with an orifice for the entry of the product (liquid) contained in the container. Said orifice is opened or closed by a valve, slidably movable within the containment body, in particular within a dosing chamber included therein.

The dosing chamber is defined by the space present between a piston, guided by an internally hollow stem, able to slide within the containment body and the bottom portion (where the orifice is positioned) of the containment body.

A dispensing cavity of the hollow stem is selectively closed/opened. When the dispensing cavity is opened, the interior of the hollow stem is in fluid communication with the dosing chamber.

The hollow stem is guided in its travel by a retaining ring, integral with the containment body, which also serves as an abutment for the travel of the piston.

In other words, the retaining ring defines the upper limit of the dosing chamber, preventing the piston from being able to exit from the dosing chamber itself.

When the piston creates an overpressure within the dosing chamber, the dispensing cavity of the hollow stem is in fluid communication with the dosing chamber and the liquid present in the dosing chamber rises along the hollow stem.

In this configuration, the valve is lowered and occludes the aforementioned orifice because of the overpressure in the dosing chamber.

When the piston creates a vacuum within the dosing chamber the dispensing cavity of the hollow stem is not in fluid communication with the dosing chamber and the liquid is moved from the container into the dosing chamber.

In this configuration, the valve is raised and leaves open the aforementioned orifice because of the vacuum in the dosing chamber.

In this type of dispensing pump, the lowering of the piston within the containment body takes place contrasting the action of a spring whose function is to maintain the piston in raised position.

In particular, when a compression action is exercised on the hollow stem, the piston slides within the dosing chamber, reducing its dimensions and hence creating an overpressure within it.

Ceasing the compression action on the hollow stem, the aforementioned spring brings the piston back to the raised position, expanding the dimensions of the dosing chamber and hence creating a vacuum therein. At each dispensing action a volume of air equal to the dispensed liquid enters the container to maintain a pressure equilibrium between the interior of the container and the outside atmosphere.

In the dispensing pumps according to the prior art the hollow stem is associated inferiorly to the piston and superiorly to a dispensing spout, to command the operation of the piston and to dispense the product contained in the container.

When it is necessary to collect the dispensed product in a cup, as, for example, in case of liquid laundry detergent, concentrated beverages flavor enhancers (i.e. lemonade), liquid medicine (i.e. cough medicine), food condiments (ketchup, mustard), food and drink syrups (chocolate or coffee additives) or oral mouth rinses, the prior art dispensing pumps are not satisfactory.

In fact, usually the cup is not provided at all, or can be provided as an additional (separated) part, to be used in combination with the dispensing pump. In this case, the user has to handle the cup separately from the dispensing pump, with the risk that the product can pour out the cup causing mess. Furthermore there is also the risk to lose the cup.

Sometimes, the only cup is provided, to be used simply as a metering device in which the liquid is poured directly from the container. In this case, the metered dose is quite rough and not regular.

These drawbacks are particularly relevant when a clean and reliable dispensing action is required.

### DISCLOSURE OF THE INVENTION

In this context, the technical task at the basis of the present invention is to propose an actuating device for a dispensing pump of a dispenser that overcomes the aforementioned drawbacks of the prior art.

In particular, an object of the present invention is to make available an actuating device for a dispensing pump of a dispenser that allows a clean and reliable dispensing action.

More in particular, an object of the present invention is to make available an actuating device for a dispensing pump of a dispenser, that includes, as a combined part, a pouring cup to be filled with a product (liquid), by taking it from a container below the pouring cup through a dispensing pump and let it flow from the top inside the pouring cup, without mess and product loss.

Moreover an object of the present invention is to make available an actuating device for a dispensing pump of a dispenser that allows the user to avoid measuring the amount of product to be used.

A further object of the present invention is to make available an actuating device for a dispensing pump of a dispenser that allows the user to cleanly and easily remove the filled pouring cup and for example to use it for pouring the product inside the vane of the washing machine or for example to put it into the washing machine drum.

The specified technical task and the objects set out above are substantially achieved by an actuating device for a dispensing pump of a dispenser, comprising the technical characteristics exposed in one or more of the appended claims. Dependent claims corresponds to possible embodiments of the invention.

In particular, according to a first aspect, the invention relates to an actuating device for a dispensing pump of a dispenser configured to be used on a container, in an upward position of the container, the actuating device comprising a pouring cup and a connecting device,

wherein the pouring cup defines an inner chamber for receiving a metered amount of a product contained in the container,
wherein the connecting device comprises a hollow structure extending along a longitudinal axis between at least a first end and a second end, opposite to the first end, the hollow structure being connected and supporting the pouring cup,
wherein the hollow structure defines a channel extending along said longitudinal axis between at least an input opening and at least an output opening,
wherein said at least one output opening emerges into the inner chamber whereby the channel of the hollow structure of the connecting device is in fluid communication with the inner chamber of the pouring cup,
wherein the second end of the hollow structure comprises a connecting portion configured to be connected to a hollow stem of the dispensing pump whereby said channel of the hollow structure is in fluid communication with a dispensing cavity defined by the hollow stem of the dispensing pump,
wherein the connecting portion of the hollow structure is configured to transmit to the hollow stem of the dispensing pump a force applied to the hollow structure and directed along said longitudinal axis for axially moving the hollow stem within the dispensing pump, and
wherein the connecting portion of the hollow structure is configured to transmit to the hollow stem of the dispensing pump a torque applied to the hollow structure for rotate the hollow stem around the longitudinal axis within the dispensing pump.

The actuating device according to the invention allows to fill the pouring cup with a product, by taking it from a container below the pouring cup through a dispensing pump and let it flow from the top inside the pouring cup, without mess and product loss. Moreover the dispensing pump dispenses the exact dose.

Preferably the inner chamber of the pouring cup has an annular configuration around the connecting device. The first end of the hollow structure and the output opening of the channel are disposed centrally within the inner chamber.

The actuating device is therefore structurally simple and has contained dimensions.

Preferably the pouring cup and the connecting device are structurally separated. The pouring cup is assembled on the connecting device engaging with the hollow structure. The filled pouring cup could be therefore cleanly removable from the container.

Preferably the pouring cup has an inner wall defining a central seat configured to receive the connecting device being inserted along the longitudinal axis.

Preferably the inner wall of the pouring cup has a central hole configured to engage the connecting device, the first end of the hollow structure and the output opening of the channel being disposed within the inner chamber in an assembled configuration of the pouring cup on the connecting device.

Preferably the inner wall of the pouring cup has a first conic surface disposed around the central hole and within the central seat. The hollow structure has a second conic surface configured to be in contact with the first conic surface, in an assembled configuration of the pouring cup on the connecting device, sealing the central hole. The actuating device is therefore structurally simple and allows the product to cleanly flow into the cup and not to flow down on the actuating device.

Preferably the inner wall of the pouring cup comprises undercuts cooperating with a flange of the hollow structure to ensure retention of the pouring cup on the connecting device. The arrangement of the cup on the actuating device is therefore reliable and sure.

Preferably the pouring cup and the connecting device comprise an anti-rotational system configured to transmit to the connecting device the torque applied to the pouring cup. The anti-rotational arrangement of the pouring cup and the connecting device allows to unlock the dispensing pump, in particular at the first use.

Preferably the anti-rotational system comprises:
ribs extending from the inner wall of the pouring cup within the central seat, the ribs being disposed along a direction parallel to the longitudinal axis and
at least one tooth extending from a flange of the hollow structure and co-operating with the ribs configured to transmit to the connecting device the torque applied to the pouring cup.

The arrangement of the anti-rotational system is therefore reliable and the actuating device is structurally simple.

Preferably the pouring cup comprises ribs extending from the inner wall of the pouring cup within the central seat. The ribs are disposed along a direction parallel to the longitudinal axis and are supported by a flange of the hollow structure to transmit to the connecting device a force applied to the pouring cup and directed along said longitudinal axis for axially moving the hollow stem within the dispensing pump. This arrangement allows to reliably transmit the actuating force from the cup to the dispensing pump. Preferably the pouring cup is assembled on the connecting device in a removable way. The filled pouring cup is therefore cleanly removable from the container.

Preferably the pouring cup comprises a bowl and a lid covering and closing at least partially the bowl allowing an easy actuation of the dispensing pump, by pushing the lid.

Preferably the lid has an aperture to pour the product from the inner chamber. The aperture allows the user to pour the product for example into the washing machine. Furthermore this aperture can be calibrated to be enough large to let the product flow out properly and mix with water, if the pouring cup closed by the lid is put into the machine drum.

Preferably the lid has a protrusion extending from an internal surface of the lid within the inner chamber. The protrusion is configured to touch the first end of the hollow structure of the connecting device. The protrusion allows to transfer the pressure the user applies on the lid, to the actuating device and then to the dispensing pump.

Preferably the protrusion has a ring configuration to uniformly transfer the pressure.

Preferably the lid is connected to the bowl in a removable way in order to easily clean the cup.

Preferably the pouring cup has an external wall comprising a stepped portion delimiting an insertion portion configured to be inserted within a crown portion of the container in order to have a compact container at least in a locked position of the dispensing pump.

Preferably the connecting portion of the hollow structure is configured to be connected to the hollow stem of the dispensing pump whereby the channel of the hollow structure is coaxial with the dispensing cavity defined by the hollow stem of the dispensing pump allowing a continuous dispensing of the product from the container to the cup.

Preferably the hollow structure comprises a cylindrical portion having substantially the same diameter of the hollow stem in order to guide the actuating device and to aesthetically harmonize its profile with the hollow the stem on which it is assembled.

Preferably the connecting portion of the hollow structure extends from the cylindrical portion and is configured to be inserted within a receiving seat of the hollow stem to allow a sure and easy assembling.

Preferably the connecting portion of the hollow structure comprises undercuts to ensure retention within the receiving seat of the hollow stem. Preferably the connecting portion of the hollow structure comprises a sealing portion cooperating with the receiving seat of the hollow stem. Preferably the connecting portion of the hollow structure comprises an anti-rotational system between the connecting device and the hollow stem. According to a second aspect, the invention relates to a dispenser comprising an actuating device and a dispensing pump comprising:
a hollow containment body configured to be inserted and fixed in a body of a container and comprising an orifice for the suction of a product from said container,
a hollow stem extending along the longitudinal axis and configured to slide within said containment body between a raised position and a lowered position along the longitudinal axis, the hollow stem having a first end associated to a piston and a second end associated to the connecting portion of the hollow structure of the connecting device,
a retaining ring integral with the hollow containment body and inserted within said hollow containment body to guide the hollow stem,
   wherein the pouring cup and the connecting device are configured to be integral with the hollow stem during its axial sliding and
   wherein the connecting device is configured to be integral with the hollow stem during an unlocking rotational movement of the hollow stem around the longitudinal axis.

Preferably the inner chamber of the pouring cup has an annular configuration around the connecting device. The first end of the hollow structure and the output opening of the channel are disposed centrally within the inner chamber. The retaining ring comprises an upper portion extending towards the output opening and configured to be received within a central seat of the pouring cup.

According to a further aspect, the invention relates to a container comprising a body having an opening, a dispenser inserted in said opening, a closure fitted on said opening, said closure comprising a crown portion extending outwardly, wherein the pouring cup has an external wall comprising a stepped portion delimiting an insertion portion configured to be inserted within a crown portion in the lowered position of the hollow stem.

Preferably the dispenser, in particular the hollow containment body of the dispensing pump, comprises a retaining flange resting on a rim of said opening.

Preferably the closure has a passage for a portion of the dispenser and is configured to fasten the retaining flange of the dispenser against the rim of the opening.

### BRIEF DESCRIPTION OF DRAWINGS

Further characteristics and advantages of the present invention shall become more readily apparent from the indicative, and therefore not limiting, description of a preferred but not exclusive embodiment of a an actuating device for a dispensing pump of a dispenser, as illustrated in the accompanying drawings in which:

FIG. 1 is a sectioned and partial view of a container with a dispenser in accordance with the present invention;

FIG. 2 is a perspective view of a pouring cup and a connecting device in accordance with the present invention;

FIG. 3 is a sectioned view of the pouring cup and the connecting device of FIG. 2;

FIG. 4 is a perspective view of the pouring cup and the connecting device of FIG. 2 in an assembled configuration;

FIG. 5 is a sectioned view of the pouring cup and the connecting device of FIG. 4;

FIG. 6 is a perspective view of the pouring cup and the connecting device of FIG. 2 in an assembled configuration;

FIG. 7 is an enlarged view of detail A of FIG. 6;

FIG. 8 is a sectioned and partial view of a container with a dispenser in accordance with the present invention;

FIG. 9 is a partial view of a container with a dispenser in accordance with the present invention.

### DETAILED DESCRIPTION OF PREFERRED EMBODIMENTS OF THE INVENTION

With reference to the accompanying drawings, an actuating device for a dispensing pump in accordance with the present invention is indicated with the reference 1 and a dispensing pump is indicated with 2. The dispenser comprising an actuating device 1 and a dispensing pump 2 is indicated with 3 and a container comprising a body 4a and a dispenser 3 is indicated with 4.

The dispensing pump 2 can be realized according to the disclosure of WO2011/074024 herein incorporated by reference. In particular the dispensing pump 2 comprises a hollow containment body 5 configured to be inserted and fixed in the body 4a of the container, for example a bottle. The hollow containment body 5 of the dispensing pump 2 has axial-symmetric geometry and is provided with an orifice 6 through which the liquid contained in the body 4a of the container 4 enters a dosing chamber (not shown) of the hollow containment body 5. A valve (not shown) is positioned inside the hollow containment body 5 to open and shut the orifice 6.

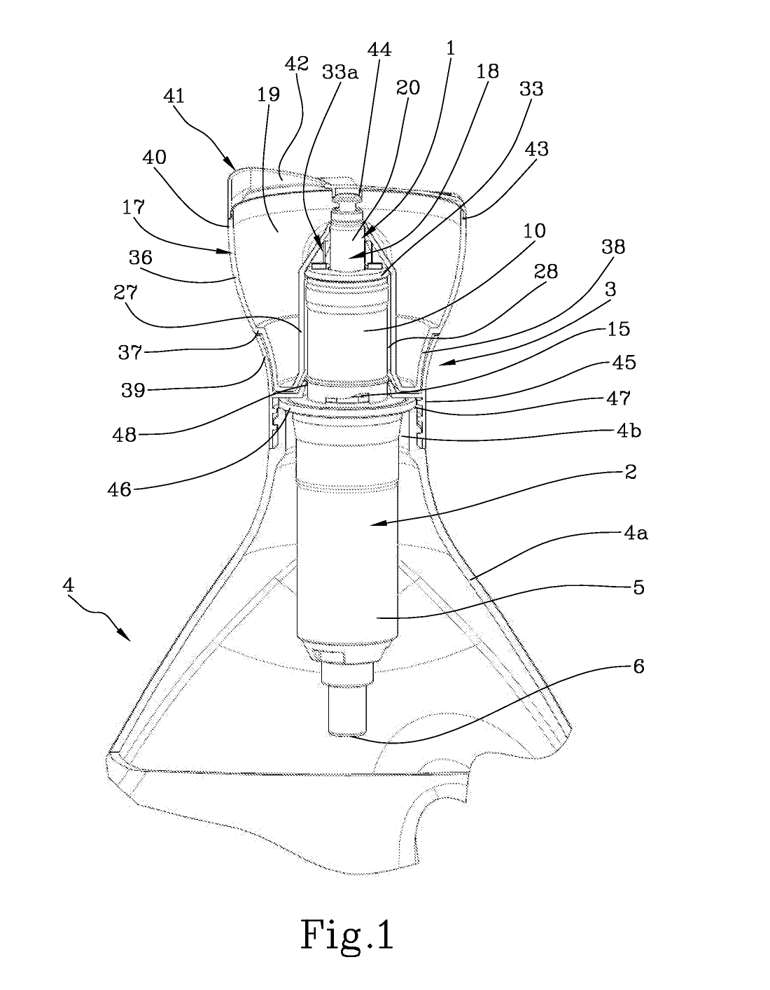

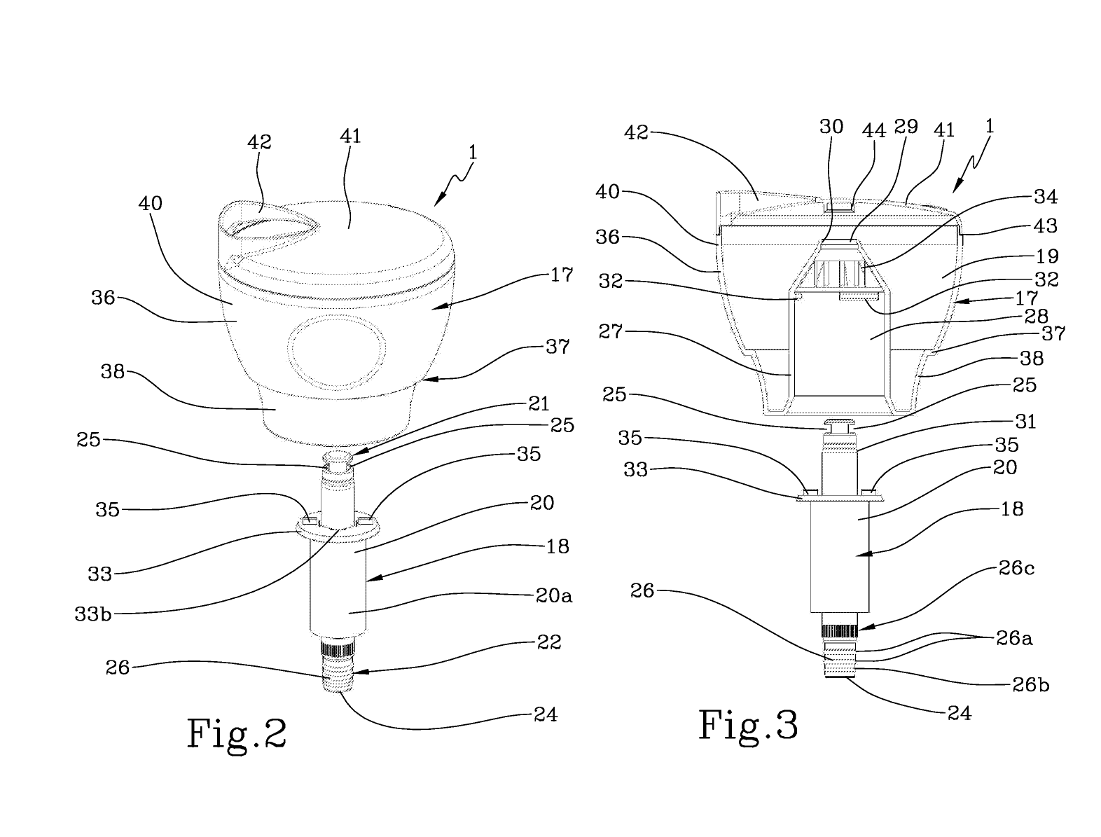

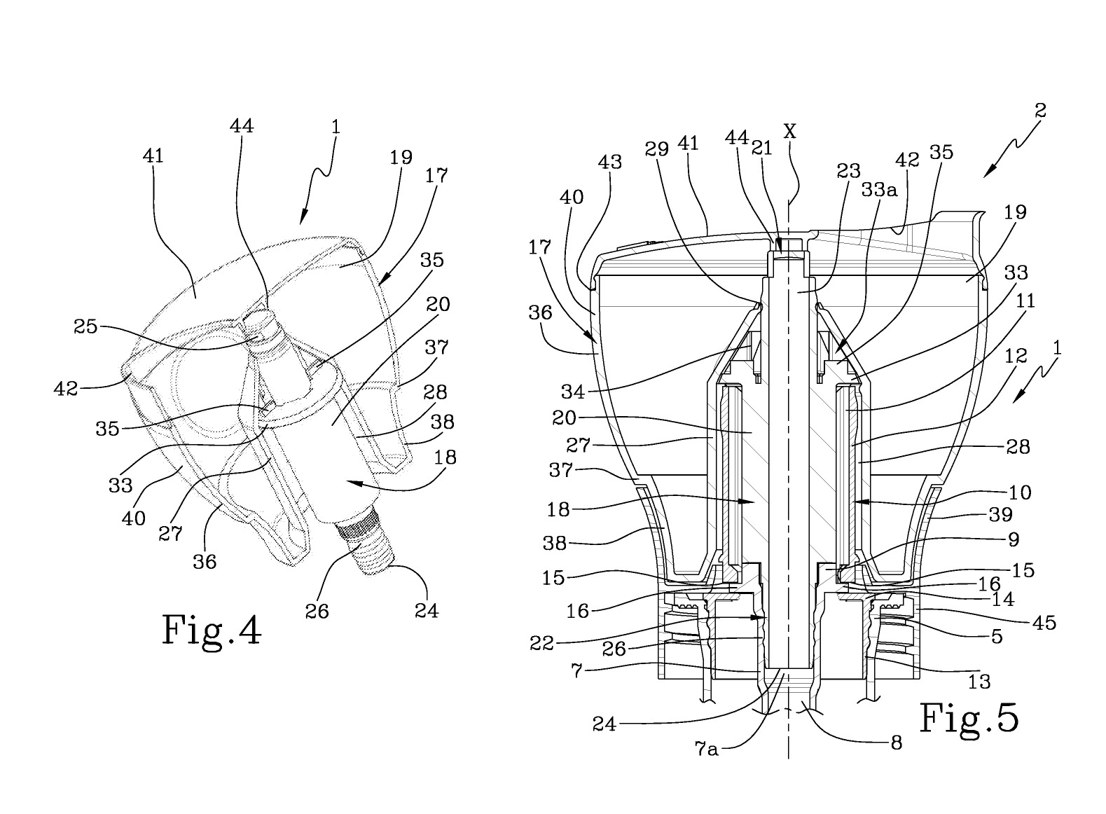

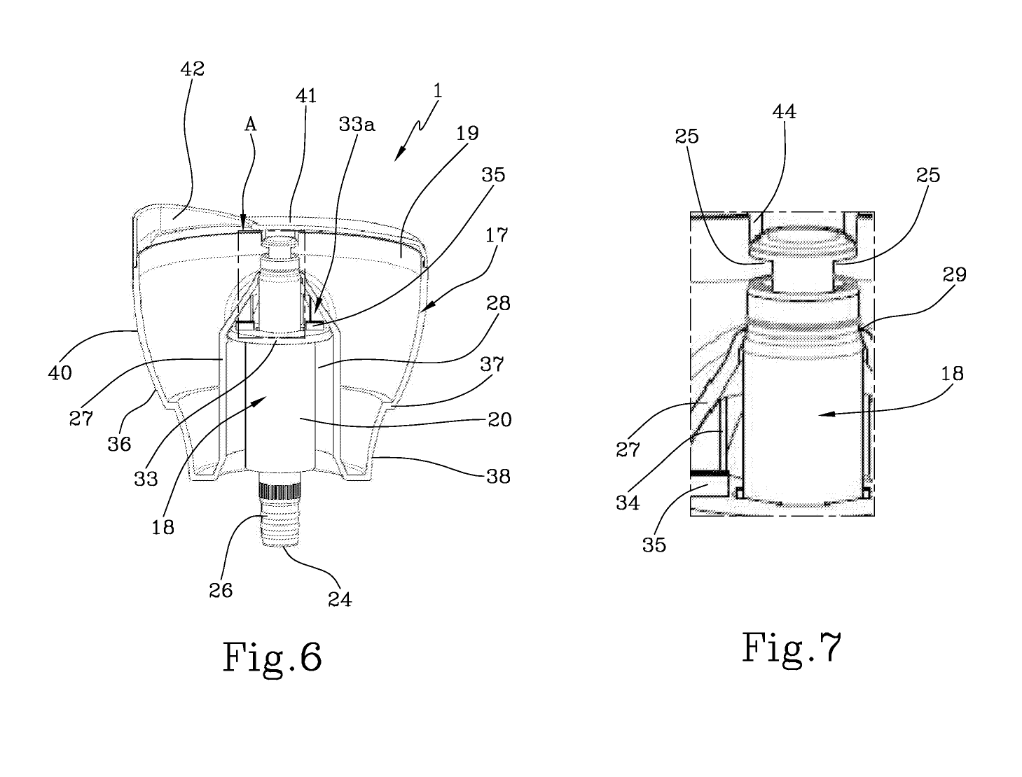

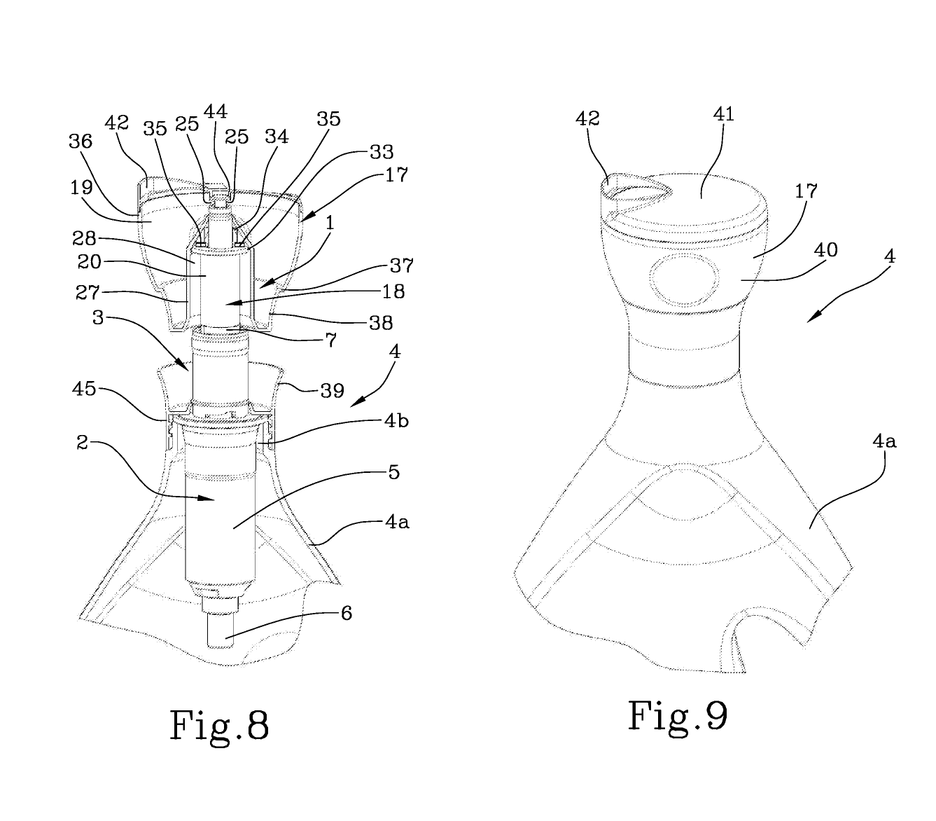

The dispensing pump 2 comprises a hollow stem 7 extending along a longitudinal axis X and configured to slide axially within the hollow containment body 5 between a raised position (FIG. 8) and a lowered position (FIG. 1). The hollow stem 7 has a dispensing cavity 8 extending along the longitudinal axis X configured to receive the product from the dosing chamber of the hollow containment body 5.

Within the hollow containment body 5 is provided a piston (not shown) associated to a first end of the hollow stem 7, therefore movable between a raised position and a lowered position following the axial movement of the hollow stem in order to change the volume of the dosing chamber. A second end 9 of the hollow stem 7 is opposite to the first end.

To guide the hollow stem 7 in its stroke within the hollow containment body 5, the dispensing pump 2 comprises a retaining ring 10 integral with the hollow containment body 5 and inserted therein. The retaining ring 10 has a hole 11 for the passage of the hollow stem 7 and presents an upper portion 12 and a lower portion 13 delimited by a flange 14.

Moreover, the retaining ring 10 presents at least two undercuts 15, positioned at diametrically opposite sides, below which fins 16 of the hollow stem 7 are engaged by interference, to maintain the hollow stem in lowered position and the dispensing pump locked.

The dispensing pump comprises elastic means (not shown) contrasting the free sliding of the hollow stem 7 within the hollow containment body 5. According to an embodiment the elastic means comprise a spring housed between the retaining ring 10 and the hollow stem 7 and configured to maintain the hollow stem in the raised position.

The actuating device 1 is configured to be used in an upward position of the container, and comprises a pouring cup 17 and a connecting device 18.

The pouring cup 17 defines an inner chamber 19 for receiving a metered amount of a product contained in the body 4a of the container through the dosing chamber of the hollow containment body 5, the dispensing cavity of the hollow stem 7 and the connecting device 18.

The connecting device 18 comprises a hollow structure 20 extending along the longitudinal axis X in an assembled configuration of the dispenser. In particular the connecting device 18 extends between at least a first end 21 and a second end 22, opposite to the first end 21.

The hollow structure 20 is connected to the pouring cup 17 and supports the pouring cup 17.

The hollow structure 20 defines a channel 23 extending along the longitudinal axis X between at least an input opening 24 and at least an output opening 25. The embodiment disclosed in the figures shows two output openings 25 positioned at diametrically opposite sides.

The output opening 25 emerges into the inner chamber 19 whereby the channel 23 of the hollow structure 20 of the connecting device 18 is in fluid communication with the inner chamber 19 of the pouring cup 17.

The second end 22 of the hollow structure 20 comprises a connecting portion 26 configured to be connected to the hollow stem 7 of the dispensing pump whereby the channel 23 of the hollow structure 20 is in fluid communication with the dispensing cavity 8 defined by the hollow stem 7 of the dispensing pump 2. In particular the connecting portion 26 of the hollow structure 20 is configured to be connected to the hollow stem 7 of the dispensing pump 2 whereby the channel 23 of the hollow structure 20 is coaxial with the dispensing cavity 8 defined by the hollow stem 7 of the dispensing pump 2.

The connecting portion 26 of the hollow structure 20 is configured to transmit to the hollow stem 7 of the dispensing pump 2 a force applied to the hollow structure 20 and directed along the longitudinal axis X for axially moving the hollow stem 7 within the dispensing pump 2.

Moreover the connecting portion 26 of the hollow structure 20 is configured to transmit to the hollow stem 7 of the dispensing pump 2 a torque applied to the hollow structure 20 for rotate the hollow stem 7 around the longitudinal axis X within the dispensing pump 2.

Preferably the hollow structure 20 comprises a cylindrical portion 20a having substantially the same diameter of the hollow stem 7 suitable for guiding the connecting device and harmonizing its profile with the hollow stem on which it is assembled.

According to an embodiment of the invention, the connecting portion 26 of the hollow structure 20 extends from the cylindrical portion 20a and is configured to be inserted within a receiving seat 7a of the hollow stem 7 (FIG. 5).

Preferably the connecting portion 26 of the hollow structure 20 comprises at least one between:
undercuts 26a to ensure retention within the receiving seat 7a of the hollow stem 7;
a sealing portion 26b cooperating with the receiving seat 7a of the hollow stem 7;
an anti-rotational system 26c between the connecting device 18 and the hollow stem 7.

Preferably the inner chamber 19 of the pouring cup 17 has an annular configuration around the connecting device 18. The first end 21 of the hollow structure 20 and the output opening 25 of the channel 23 are disposed centrally within the inner chamber 19.

Preferably the pouring cup 17 and the connecting device 18 are structurally separated, as for example shown in the figures, and the pouring cup 17 is assembled on the connecting device 18 engaging with the hollow structure 20 (FIG. 5).

In particular the pouring cup 17 has an inner wall 27 defining a central seat 28 configured to receive the connecting device 18 inserted along the longitudinal axis X. In particular the retaining ring 10 comprises an upper portion 12 extending towards the output opening 25 and configured to be received within the central seat 28 of the pouring cup 17.

Preferably the inner wall 27 of the pouring cup 17 has central hole 29 configured to engage the connecting device 18. The first end 21 of the hollow structure 20 and the output opening 25 of the channel 23 are disposed within the inner chamber 19 in an assembled configuration of the pouring cup 17 on the connecting device 18.

Preferably the inner wall 27 of the pouring cup 17 has a first conic surface 30 disposed around the central hole 29 and within the central seat 28. Moreover the hollow structure 20 has a second conic surface 31 configured to touch the first conic surface 30, in an assembled configuration of the pouring cup 17 on the connecting device 18, sealing the central hole 29 (FIG. 3). In particular the shape of the inner wall 27 around the central hole 29 and the shape of the hollow structure 20 are designed to reciprocally touch so that the product can flow cleanly into the pouring cup from the output opening 25. Moreover the central hole 29 is placed in the higher part of the inner wall 27 so that the pouring cup, once filled, can be comfortably used without the product going out of the pouring cup.

According to an embodiment of the invention, the inner wall 27 of the pouring cup 17 comprises undercuts 32 (FIG. 3) cooperating with a flange 33 of the hollow structure 20 to ensure retention of the pouring cup 17 on the connecting device 18. Some cuts 33b are provided on the flange 33 to avoid the product creating mess on the flange.

According to an embodiment of the invention, the pouring cup 17 and the connecting device 18 comprise an anti-rotational system 33a configured to transmit to the connecting device 18 the torque applied to the pouring cup 17. Preferably the anti-rotational system 33a comprises ribs 34 extending from the inner wall 27 of the pouring cup 17 within the central seat 28. The ribs 34 are disposed along a direction parallel to the longitudinal axis X. In use the container rests on a horizontal surface whereby the longitudinal axis X is vertical, therefore the ribs 34 are disposed along a vertical direction. Moreover the anti-rotational system 33a comprises at least one tooth 35 (preferably two teeth 35 as shown in the figures) extending from the flange 33 of the hollow structure 20. The ribs 34 and the teeth 35 co-operate to transmit to the connecting device 18 the torque applied to the pouring cup 17.

Moreover the ribs 34 are supported by the flange 33 of the hollow structure 20 to transmit to the connecting device 18 a force applied to the pouring cup 17 and directed along the longitudinal axis X in order to axially move the hollow stem 7 within the dispensing pump 2. More particularly, ribs 34 are the interface with the flange 33 of the connecting device 18 to keep the pouring cup 17 in place and transfer force, whereby by pushing on the pouring cup 17 the force is transferred to the connecting device via ribs 34.

According to an embodiment of the invention, the pouring cup 17 is assembled on the connecting device 18 in a removable or detachable way. In particular the pouring cup can be easily detached and re-attached onto the connecting device through which it is connected to the dispensing pump. Nevertheless, the pouring cup can also be used without being detached from the connecting device (and thus from the body of the container), in which case the product is poured by using the whole container. Alternatively, according to an embodiment of the invention (not shown), the pouring cup cannot be removed or detached from the connecting device.

According to an embodiment of the invention (not shown), the pouring cup and the connecting device are made in one piece.

With reference to the pouring cup 17, it is preferably a cylindrical container.

According to an embodiment of the invention the pouring cup 17 has an external wall 36 comprising a stepped portion 37 delimiting an insertion portion 38 configured to be inserted within a crown portion 39 of the container. Therefore the external wall 36 is designed in order to let the pouring cup be partially hidden under the crown portion 39, when the dispensing pump is locked.

According to an embodiment of the invention the pouring cup 17 comprises a bowl 40 and a lid 41 covering and closing at least partially the bowl. Preferably the lid 41 has an aperture 42 to pour the product from the inner chamber 19. Preferably the aperture 42 is calibrated to be enough large to let the product flow out properly and mix with water, if the poring cup is put into the washing machine drum.

Preferably the lid 41 is connected to the bowl 40 in a removable or detachable way. In particular on the top part of the bowl 40 there is an undercut 43 that is thought to assemble the bowl with the lid and keep it solidly in place.

According to an embodiment of the invention, in particular when the lid 41 is connected to the bowl 40 in a removable or detachable way, the lid 41 has a protrusion 44 extending from an internal surface of the lid 41 within the inner chamber 19. The protrusion 44 is configured to touch the first end 21 of the hollow structure 20 of the connecting device 18. In particular the protrusion 44 has a ring configuration embracing the first end 21 of the hollow structure 20 of the connecting device 18. Through the contact between the protrusion 44 and the connecting device 18 the pressure the user applies on the lid is transmitted to the connecting device and then to the dispensing pump.

The dispenser 3 according to the invention comprises an actuating device 1 as disclosed above and a dispensing pump 2 as disclosed above. The pouring cup 17 and the connecting device 18 are configured to be integral with the hollow stem 7 during its axial sliding. Moreover the connecting device 18 (and the pouring cup 17) is configured to be integral with the hollow stem 7 during an unlocking rotational movement of the hollow stem 7 around the longitudinal axis X.

The body 4a of the container 4 has an opening 4b. The dispenser 3 is inserted in the opening 4b and a closure 45 is fitted on said opening. The closure 45 comprises the crown portion 39 extending outwardly. The insertion portion 38 of the pouring cup 17 is configured to be inserted within the crown portion 39 in the lowered position of the hollow stem 7. The dispenser 3, and in particular the dispensing pump 2, comprises a retaining flange 46 resting on a rim 47 of the opening 4b.

The closure 45 has a passage 48 for a portion of the dispenser 3, in particular for the upper portion 12 of the retaining ring 10 and is configured to fasten the retaining flange 46 of the dispenser 43 against the rim 47 of the opening 4b.

In use by pressing on the lid 41, the hollow stem 7 and the piston translate within the dosing chamber of the dispensing pump 2.

The travel of the hollow stem 7 causes a compression of the liquid present in the dosing chamber which flows through dispensing cavity of the hollow stem 7 and hence through the channel 23 of the hollow structure reaching the output opening 25 and flowing within the inner chamber 19. During this phase the spring of the dispensing pump is compressed.

As a result of the release of the lid 41 by the user, the entire system returns to the resting position thanks to the thrust of the spring of the dispensing pump.

During the rising phase, the piston closes the dispensing cavity of the hollow stem 7 and creates a depression inside the dosing chamber of the pump which determines the aspiration of liquid through the orifice 6 of the containment body 5.

In particular, through the connecting device, the action of the user is transmitted to the dispensing pump. The first end of the connecting device is slidably engaged with the pouring cup for making the product flow properly into the cup and avoiding the product go out.

The connecting device has the two functions: sustaining the pouring cup and making the dispensing pump work.

The container is sold in a locked down position, as shown in FIG. 5. At the first use, the consumer unlocks the dispenser rotating the pouring cup 17. The torque applied on the pouring cup 17 is transmitted to the connecting device 18 by ribs 34 and teeth 35. The connecting device 18 is solidly on the hollow stem 7 which rotates around the longitudinal axis X unlocking the dispensing pump 2.

When the dispensing pump 2 is unlocked, the connecting device 18 is pushed up together with the pouring cup 17.

Then the pouring cup operates in combination with the connecting device to allow a user to actuate the dispensing pump. The dispensing pump sucks the product from the container that stands in its normal upward position and discharges it into the pouring cup.

In particular the user then pushes on the lid 41 of the pouring cup 17 to obtain the dose. The action is transferred to the dispensing pump 2 through the connecting device 18 which is in this case a vertical prosecution of the hollow stem 7. The product is moved this way upwardly from the container, through the dispensing pump, to the pouring cup. The user can decide whether to fill the pouring cup with a predetermined number of doses which can be related to the capacity of the inner chamber 19.

Once the pouring cup is filled with the desired amount of product (detergent as main reference), the user can decide whether to pour the product which is inside the pouring cup by lifting the container or to remove the pouring cup.

The stand-alone pouring cup then could be used to pour the product into the washing machine vane or to be placed directly into the drum.

The combination of pouring a cup with a connecting device allows an actuating device for a dispensing pump to be used on a container, in the normal upward position, to collect the product delivered through said dispensing pump. In particular the pouring cup and the connecting device are displaced in the axial direction to actuate the dispensing pump.

According to the embodiment in which the pouring cup is not detachable, the liquid is poured by using the whole container.

According to the embodiment in which the pouring cup is detachable, the user can remove cleanly the filled cup from the connecting device for example for pouring the product inside the washing machine vane or for putting the pouring cup into the washing machine drum.

In both the cases, i.e. either detaching the pouring cup or not, the liquid is delivered in two steps: first it is sucked by the container and collected into the pouring cup (the product flows out from the top part of the connecting device positioned on the longitudinal axis of the dispensing system), then it is poured out from the pouring cup itself.

The pouring cup has an internal shape that replicates the design of the connecting device to allow an easy and comfortable detaching and to preserve, at the same time, the proper flowing of the product into the pouring cup avoiding loss of product or dirtying.

The present invention can be used for example for liquid laundry detergent, concentrated beverages flavor enhancer, liquid medicine, food condiments, food and drink syrups, oral mouth rinses.

The present invention allows to fill a pouring cup with liquid, by taking it from a container below the pouring cup though a dispensing pump and let it flow from the top inside the pouring cup, without mess and product loss. Moreover the present invention allows the user to avoid measuring the amount of product to be used, since the dispensing pump dispenses the exact dose. When the pouring cup is detachable from the connecting device, the present invention allows the user to remove it cleanly. In particular the pouring cup provided with the lid is easily removable axially.

What is claimed is:

1. Actuating device for a dispensing pump of a dispenser configured to be used on a container, in an upward position of the container, the actuating device comprising a pouring cup and a connecting device,
wherein the pouring cup defines an inner chamber for receiving a metered amount of a product contained in the container,
wherein the connecting device comprises a hollow structure extending along a longitudinal axis between at least a first end and a second end, opposite to the first end, the hollow structure being connected and supporting the pouring cup,
wherein the hollow structure defines a channel extending along said longitudinal axis between at least an input opening and at least an output opening,
wherein said at least one output opening emerges into the inner chamber whereby the channel of the hollow structure of the connecting device is in fluid communication with the inner chamber of the pouring cup,
wherein the second end of the hollow structure comprises a connecting portion configured to be connected to a hollow stem of the dispensing pump whereby said channel of the hollow structure is in fluid communication with a dispensing cavity defined by the hollow stem of the dispensing pump,
wherein the connecting portion of the hollow structure is configured to transmit to the hollow stem of the dispensing pump a force applied to the hollow structure and directed along said longitudinal axis for axially moving the hollow stem within the dispensing pump, and
wherein the connecting portion of the hollow structure is configured to transmit to the hollow stem of the dispensing pump a torque applied to the hollow structure for rotating the hollow stem around the longitudinal axis within the dispensing pump.

2. Actuating device according to claim 1 wherein the inner chamber of the pouring cup has an annular configuration around the connecting device, the first end of the hollow structure and the output opening of the channel being disposed centrally within the inner chamber.

3. Actuating device according to claim 2, wherein the pouring cup and the connecting device are structurally separated, the pouring cup being assembled on the connecting device engaging with the hollow structure.

4. Actuating device according to claim 3, wherein the pouring cup has an inner wall defining a central seat configured to receive the connecting device being inserted along the longitudinal axis.

5. Actuating device according to claim 4, wherein the inner wall of the pouring cup has a central hole configured to engage the connecting device, the first end of the hollow structure and the output opening of the channel being disposed within the inner chamber in an assembled configuration of the pouring cup on the connecting device.

6. Actuating device according to claim 5, wherein the inner wall of the pouring cup has a first conic surface disposed around the central hole and within the central seat, and wherein the hollow structure has a second conic surface configured to make contact with the first conic surface, in an assembled configuration of the pouring cup on the connecting device, sealing the central hole.

7. Actuating device according to claim 4, wherein the inner wall of the pouring cup comprises undercuts cooperating with a flange of the hollow structure to ensure retention of the pouring cup on the connecting device.

8. Actuating device according to claim 4, wherein the pouring cup and the connecting device comprise an anti-rotational system configured to transmit to the connecting device the torque applied to the pouring cup.

9. Actuating device according to claim 8, wherein the anti-rotational system comprises:
ribs extending from the inner wall of the pouring cup within the central seat, said ribs being disposed along a direction parallel to the longitudinal axis and
at least one tooth extending from a flange of the hollow structure and co-operating with said ribs configured to transmit to the connecting device the torque applied to the pouring cup.

10. Actuating device according to claim 4, wherein the pouring cup comprises ribs extending from the inner wall of the pouring cup within the central seat, said ribs being disposed along a direction parallel to the longitudinal axis and being supported by a flange of the hollow structure to transmit to the connecting device a force applied to the pouring cup and directed along said longitudinal axis for axially moving the hollow stem within the dispensing pump.

11. Actuating device according to claim 3, wherein the pouring cup is assembled on the connecting device in a removable way.

12. Actuating device according to claim 1 wherein the pouring cup comprises a bowl and a lid covering and closing at least partially the bowl.

13. Actuating device according to claim 12, wherein the lid has an aperture to pour the product from the inner chamber.

14. Actuating device according to claim 12, wherein the lid has a protrusion extending from an internal surface of the lid within the inner chamber, the protrusion making contact with the first end of the hollow structure of the connecting device.

15. Actuating device according to claim 14, wherein the protrusion has a ring configuration.

16. Actuating device according to claim 12, wherein the lid is connected to the bowl in a removable way.

17. Actuating device according to claim 1, wherein the pouring cup has an external wall comprising a stepped portion delimiting an insertion portion configured to be inserted within a crown portion of the container.

18. Actuating device according to claim 1, wherein the connecting portion of the hollow structure is configured to be connected to the hollow stem of the dispensing pump whereby said channel of the hollow structure is coaxial with the dispensing cavity defined by the hollow stem of the dispensing pump.

19. Actuating device according to claim 1, wherein the hollow structure comprises a cylindrical portion having substantially the same diameter of the hollow stem.

20. Actuating device according to claim 19, wherein the connecting portion of the hollow structure extend from the cylindrical portion and is configured to be inserted within a receiving seat of the hollow stem.

21. Actuating device according to claim 20, wherein the connecting portion of the hollow structure comprises undercuts to ensure retention within the receiving seat of the hollow stem.

22. Actuating device according to claim 20, wherein the connecting portion of the hollow structure comprises a sealing portion cooperating with the receiving seat of the hollow stem.

23. Actuating device according to claim 20, wherein the connecting portion of the hollow structure comprises an anti-rotational system between the connecting device and the hollow stem.

24. Dispenser comprising an actuating device according to claim 1 and a dispensing pump comprising:
a hollow containment body configured to be inserted and fixed in a container and comprising an orifice for the suction of a product from said container,
a hollow stem extending along the longitudinal axis and configured to slide within said containment body between a raised position and a lowered position along the longitudinal axis, the hollow stem having a first end associated to a piston and a second end associated to the connecting portion of the hollow structure of the connecting device,
a retaining ring integral with the hollow containment body and inserted within said hollow containment body to guide the hollow stem,
wherein the pouring cup and the connecting device are configured to be integral with the hollow stem during its axial sliding and
wherein the connecting device is configured to be integral with the hollow stem during an unlocking rotational movement of the hollow stem around the longitudinal axis.

25. Dispenser according to claim 24 wherein the inner chamber of the pouring cup has an annular configuration around the connecting device, the first end of the hollow structure and the output opening of the channel being disposed centrally within the inner chamber, and
wherein said retaining ring comprises an upper portion extending towards said output opening and configured to be received within a central seat of the pouring cup.

26. Container comprising a body having an opening, a dispenser according to claim 24 inserted in said opening, a closure fitted on said opening, said closure comprising a crown portion extending outwardly, wherein the pouring cup has an external wall comprising a stepped portion delimiting an insertion portion configured to be inserted within a crown portion in the lowered position of the hollow stem.

27. Container according to claim 26 wherein the dispenser comprises a retaining flange resting on a rim of said opening.

28. Container according to claim 27 wherein the closure has a passage for a portion of the dispenser and is configured to fasten the retaining flange of the dispenser against the rim of the opening.
